(19) United States
(12) Patent Application Publication
(10) Pub. No.: US 2013/0133701 A1
(43) Pub. Date: May 30, 2013

(54) METHOD AND APPARATUS FOR DISPENSING AN INERT GAS

(71) Applicants: Satbir Kahlon, Livermore, CA (US); Frank Ma, Scotts Valley, CA (US)

(72) Inventors: Satbir Kahlon, Livermore, CA (US); Frank Ma, Scotts Valley, CA (US)

(73) Assignee: Intermolecular, Inc., San Jose, CA (US)

(21) Appl. No.: 13/305,332

(22) Filed: Nov. 28, 2011

(51) Int. Cl. B08B 3/08; B08B 7/04; B08B 5/00

(52) U.S. Cl. 134/30; 134/95.2

(57) ABSTRACT

Methods for cleaning a substrate are provided. One such method includes receiving the substrate into a cleaning module and flowing an inert gas into the cleaning module. The flowing of the inert gas includes flowing the inert gas into an inlet defined within a top surface of the cleaning module and modifying a direction of the flowing inert gas to flow radially along the top surface of the cleaning module. Concurrent with or after initiating the flowing of the inert gas, a cleaning chemistry is introduced onto a surface of the substrate. The cleaning chemistry is at a temperature elevated from an ambient temperature. The dispensing of the cleaning chemistry is terminated and the flowing of the inert gas is terminated either concurrent with or after termination of the dispensing of the cleaning chemistry. The substrate is dried after the termination of the flowing of the inert gas.

### BACKGROUND

Cleaning operations are routinely performed during semiconductor processing. A module typically used to clean semiconductor substrates is a spin rinse dry (SRD) module. The semiconductor substrate is received by the SRD module for cleaning the wafer after a semiconductor processing operation is performed. Some cleaning processes performed in the SRD utilize heated chemistries for the cleaning operation. During the cleaning operation, the introduction of heated chemistries onto the substrate surface may result in vaporization of the heated chemistry within the SRD chamber. The vaporization of the heated chemistry can cause condensation upon the SRD walls and ceiling, which may be at ambient temperature. The vapor that condenses on the SRD walls and ceiling forms droplets which have the potential to be dislodged, especially from vibration of the SRD module during high speed rotation of the substrate during the drying process. These dislodged droplets may fall onto a substrate being cleaned. The droplets may contain particles which can be deposited onto the surface of the substrate. In addition, the droplets can cause aesthetic defects on the surface of the substrate.

It is within this context that the embodiments arise.

### SUMMARY

Embodiments of the present invention provide a method and system for improving the cleaning performance of a spin rinse and dry module. Several inventive embodiments of the present invention are described below.

In some embodiments of the invention, methods for cleaning a substrate are provided. One such method includes receiving the substrate into a cleaning module and flowing an inert gas into the cleaning module. The flowing of the inert gas includes flowing the inert gas into an inlet defined within a top surface of the cleaning module and modifying a direction of the flowing inert gas to flow radially along the top surface of the cleaning module. Concurrent with or after initiating the flowing of the inert gas, a cleaning chemistry is introduced onto a surface of the substrate. The cleaning chemistry is at a temperature elevated from an ambient temperature. The dispensing of the cleaning chemistry is terminated and the flowing of the inert gas is terminated either concurrent with or after termination of the dispensing of the cleaning chemistry. The substrate is dried after the termination of the flowing of the inert gas.

Other aspects of the invention will become apparent from the following detailed description, taken in conjunction with the accompanying drawings, illustrating by way of example the principles of the invention.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a schematic diagram for implementing combinatorial processing and evaluation using primary, secondary, and tertiary screening.

FIG. 2 is a simplified schematic diagram illustrating a general methodology for combinatorial process sequence integration that includes site isolated processing and/or conventional processing in accordance with some embodiments of the invention.

FIG. 3 is a simplified schematic diagram illustrating a perspective view of a multi-module cleaning chamber with the top cleaning module and the bottom cleaning module in an open position in accordance with one embodiment of the invention.

FIG. 4 is a simplified schematic diagram illustrating a cross-sectional view of a multi-module cleaning chamber in accordance with one embodiment of the invention.

FIG. 5 is a simplified schematic diagram illustrating further details of the inert gas flow to the bottom cleaning module in accordance with some embodiments of the invention.

FIGS. 6A through 6C illustrate various alternatives for the showerhead of the cleaning showerhead in accordance with one embodiment of the invention.

### DETAILED DESCRIPTION

The following paragraphs generally describe one or more implementations of various technologies and techniques directed to enhancing the cleaning effectiveness of a spin rinse dry (SRD) module. In one implementation, the SRD module may be part of a larger combinatorial processing tool.

The embodiments describe a method for improved cleaning within a SRD module. Substrates may be cleaned utilizing cleaning chemistries at elevated temperatures, e.g., 85° C. or greater. The elevated temperatures may cause condensation to form on the ceiling of the SRD module and this condensation may cause droplets to form which can fall onto the surface of the substrate and introduce contaminants. The embodiments described below establish an inert gas curtain just prior to, or concurrent with, dispensing the cleaning chemistry at the elevated temperature onto the substrate surface. The inert gas curtain can be introduced through alternative types of showerheads as described below, where each of the showerheads directs the flow from a centrally located inlet radially along the ceiling surface of the SRD module. The inert gas, which may be nitrogen in some embodiments, forms a curtain along the top surface of the SRD reactor that effectively prevents the formation of condensation on the top surface when the heated chemistries are introduced. The discussion below is directed to certain specific implementations. It is to be understood that the discussion below is only for the purpose of enabling a person with ordinary skill in the art to make and use any subject matter defined now or later by the patent “claims” found in any issued patent herein.

Semiconductor manufacturing typically includes a series of processing steps such as cleaning, surface preparation, deposition, patterning, etching, thermal annealing, and other related unit processing steps. The precise sequencing and integration of the unit processing steps enables the formation of functional devices meeting desired performance metrics such as efficiency, power production, and reliability.

As part of the discovery, optimization and qualification of each unit process, it is desirable to be able to i) test different materials, ii) test different processing conditions within each unit process module, iii) test different sequencing and integration of processing modules within an integrated processing tool, iv) test different sequencing of processing tools in executing different process sequence integration flows, and combinations thereof in the manufacture of devices such as integrated circuits. In particular, there is a need to be able to test i) more than one material, ii) more than one processing condition, iii) more than one sequence of processing conditions, iv) more than one process sequence integration flow, and combinations thereof, collectively known as “combinatorial process sequence integration”, on a single monolithic substrate without the need of consuming the equivalent number of monolithic substrates per material(s), processing condition(s), sequence(s) of processing conditions, sequence(s) of processes, and combinations thereof. This can greatly improve both the speed and reduce the costs associated with the discovery, implementation, optimization, and qualification of material(s), process(es), and process integration sequence(s) required for manufacturing.

Systems and methods for High Productivity Combinatorial (HPC) processing are described in U.S. Pat. No. 7,544,574 filed on Feb. 10, 2006, U.S. Pat. No. 7,824,935 filed on Jul. 2, 2008, U.S. Pat. No. 7,871,928 filed on May 4, 2009, U.S. Pat. No. 7,902,063 filed on Feb. 10, 2006, and U.S. Pat. No. 7,947,531 filed on Aug. 28, 2009 which are all herein incorporated by reference. Systems and methods for HPC processing are further described in U.S. patent application Ser. No. 11/352,077 filed on Feb. 10, 2006, claiming priority from Oct. 15, 2005, U.S. patent application Ser. No. 11/419,174 filed on May 18, 2006, claiming priority from Oct. 15, 2005, U.S. patent application Ser. No. 11/674,132 filed on Feb. 12, 2007, claiming priority from Oct. 15, 2005, and U.S. patent application Ser. No. 11/674,137 filed on Feb. 12, 2007, claiming priority from Oct. 15, 2005 which are all herein incorporated by reference.

HPC processing techniques have been successfully adapted to wet chemical processing such as etching and cleaning. HPC processing techniques have also been successfully adapted to deposition processes such as physical vapor deposition (PVD), atomic layer deposition (ALD), and chemical vapor deposition (CVD).

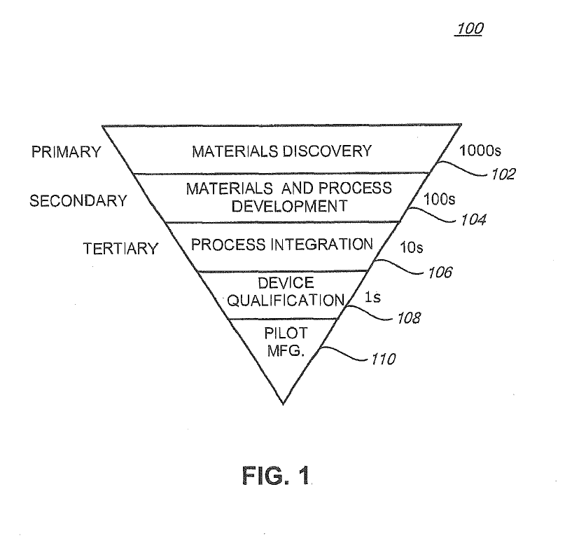

FIG. 1 illustrates a schematic diagram, 100, for implementing combinatorial processing and evaluation using primary, secondary, and tertiary screening. The schematic diagram, 100, illustrates that the relative number of combinatorial processes run with a group of substrates decreases as certain materials and/or processes are selected. Generally, combinatorial processing includes performing a large number of processes during a primary screen, selecting promising candidates from those processes, performing the selected processing during a secondary screen, selecting promising candidates from the secondary screen for a tertiary screen, and so on. In addition, feedback from later stages to earlier stages can be used to refine the success criteria and provide better screening results.

For example, thousands of materials are evaluated during a materials discovery stage, 102. Materials discovery stage, 102, is also known as a primary screening stage performed using primary screening techniques. Primary screening techniques may include dividing substrates into coupons and depositing materials using varied processes. The materials are then evaluated, and promising candidates are advanced to the secondary screen, or materials and process development stage, 104. Evaluation of the materials is performed using meteorology tools such as electronic testers and imaging tools (i.e., microscopes).

The materials and process development stage, 104, may evaluate hundreds of materials (i.e., a magnitude smaller than the primary stage) and may focus on the processes used to deposit or develop those materials. Promising materials and processes are again selected, and advanced to the tertiary screen or process integration stage, 106, where tens of materials and/or processes and combinations are evaluated. The tertiary screen or process integration stage, 106, may focus on integrating the selected processes and materials with other processes and materials.

The most promising materials and processes from the tertiary screen are advanced to device qualification, 108. In device qualification, the materials and processes selected are evaluated for high volume manufacturing, which normally is conducted on full substrates within production tools, but need not be conducted in such a manner. The results are evaluated to determine the efficacy of the selected materials and processes. If successful, the use of the screened materials and processes can proceed to pilot manufacturing, 110.

The schematic diagram, 100, is an example of various techniques that may be used to evaluate and select materials and processes for the development of new materials and processes. The descriptions of primary, secondary, etc. screening and the various stages, 102-110, are arbitrary and the stages may overlap, occur out of sequence, be described and be performed in many other ways.

This application benefits from High Productivity Combinatorial (HPC) techniques described in U.S. patent application Ser. No. 11/674,137 filed on Feb. 12, 2007 which is hereby incorporated for reference in its entirety. Portions of the '137 application have been reproduced below to enhance the understanding of the present invention. The embodiments described herein enable the application of combinatorial techniques to process sequence integration in order to arrive at a globally optimal sequence of semiconductor manufacturing operations by considering interaction effects between the unit manufacturing operations, the process conditions used to effect such unit manufacturing operations, hardware details used during the processing, as well as materials characteristics of components utilized within the unit manufacturing operations. Rather than only considering a series of local optimums, i.e., where the best conditions and materials for each manufacturing unit operation is considered in isolation, the embodiments described below consider interactions effects introduced due to the multitude of processing operations that are performed and the order in which such multitude of processing operations are performed when fabricating a device. A global optimum sequence order is therefore derived and as part of this derivation, the unit processes, unit process parameters and materials used in the unit process operations of the optimum sequence order are also considered.

The embodiments described further analyze a portion or sub-set of the overall process sequence used to manufacture a semiconductor device. Once the subset of the process sequence is identified for analysis, combinatorial process sequence integration testing is performed to optimize the materials, unit processes, hardware details, and process sequence used to build that portion of the device or structure. During the processing of some embodiments described herein, structures are formed on the processed substrate that are equivalent to the structures formed during actual production of the semiconductor device. For example, such structures may include, but would not be limited to, contact layers, buffer layers, absorber layers, or any other series of layers or unit processes that create an intermediate structure found on semiconductor devices. While the combinatorial processing varies certain materials, unit processes, hardware details, or process sequences, the composition or thickness of the layers or structures or the action of the unit process, such as cleaning, surface preparation, deposition, surface treatment, etc. is substantially uniform through each discrete region. Furthermore, while different materials or unit processes may be used for corresponding layers or steps in the formation of a structure in different regions of the substrate during the combinatorial processing, the application of each layer or use of a given unit process is substantially consistent or uniform throughout the different regions in which it is intentionally applied. Thus, the processing is uniform within a region (inter-region uniformity) and between regions (intra-region uniformity), as desired. It should be noted that the process can be varied between regions, for example, where a thickness of a layer is varied or a material may be varied between the regions, etc., as desired by the design of the experiment.

The result is a series of regions on the substrate that contain structures or unit process sequences that have been uniformly applied within that region and, as applicable, across different regions. This process uniformity allows comparison of the properties within and across the different regions such that the variations in test results are due to the varied parameter (e.g., materials, unit processes, unit process parameters, hardware details, or process sequences) and not the lack of process uniformity. In the embodiments described herein, the positions of the discrete regions on the substrate can be defined as needed, but are preferably systematized for ease of tooling and design of experimentation. In addition, the number, variants and location of structures within each region are designed to enable valid statistical analysis of the test results within each region and across regions to be performed.

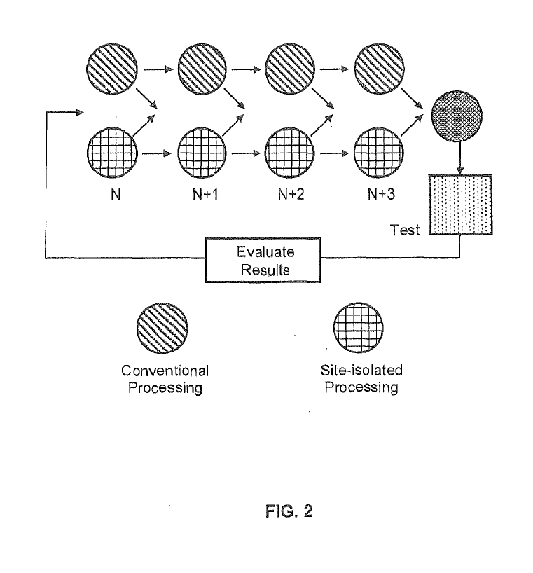

FIG. 2 is a simplified schematic diagram illustrating a general methodology for combinatorial process sequence integration that includes site isolated processing and/or conventional processing in accordance with one embodiment of the invention. In one embodiment, the substrate is initially processed using conventional process N. In one exemplary embodiment, the substrate is then processed using site isolated process N+1. During site isolated processing, an HPC module may be used, such as the HPC module described in U.S. patent application Ser. No. 11/352,077 filed on Feb. 10, 2006. The substrate can then be processed using site isolated process N+2, and thereafter processed using conventional process N+3. Testing is performed and the results are evaluated. The testing can include physical, chemical, acoustic, magnetic, electrical, optical, etc. tests. From this evaluation, a particular process from the various site isolated processes (e.g. from steps N+1 and N+2) may be selected and fixed so that additional combinatorial process sequence integration may be performed using site isolated processing for either process N or N+3. For example, a next process sequence can include processing the substrate using site isolated process N, conventional processing for processes N+1, N+2, and N+3, with testing performed thereafter.

It should be appreciated that various other combinations of conventional and combinatorial processes can be included in the processing sequence with regard to FIG. 2. That is, the combinatorial process sequence integration can be applied to any desired segments and/or portions of an overall process flow. Characterization, including physical, chemical, acoustic, magnetic, electrical, optical, etc. testing, can be performed after each process operation, and/or series of process operations within the process flow as desired. The feedback provided by the testing is used to select certain materials, processes, process conditions, and process sequences and eliminate others. Furthermore, the above flows can be applied to entire monolithic substrates, or portions of monolithic substrates such as coupons.

Under combinatorial processing operations the processing conditions at different regions can be controlled independently. Consequently, process material amounts, reactant species, processing temperatures, processing times, processing pressures, processing flow rates, processing powers, processing reagent compositions, the rates at which the reactions are quenched, deposition order of process materials, process sequence steps, hardware details, etc., can be varied from region to region on the substrate. Thus, for example, when exploring materials, a processing material delivered to a first and second region can be the same or different. If the processing material delivered to the first region is the same as the processing material delivered to the second region, this processing material can be offered to the first and second regions on the substrate at different concentrations. In addition, the material can be deposited under different processing parameters. Parameters which can be varied include, but are not limited to, process material amounts, reactant species, processing temperatures, processing times, processing pressures, processing flow rates, processing powers, processing reagent compositions, the rates at which the reactions are quenched, atmospheres in which the processes are conducted, an order in which materials are deposited, hardware details of the gas distribution assembly, etc. It should be appreciated that these process parameters are exemplary and not meant to be an exhaustive list as other process parameters commonly used in semiconductor manufacturing may be varied.

As mentioned above, within a region, the process conditions are substantially uniform, in contrast to gradient processing techniques which rely on the inherent non-uniformity of the material deposition. That is, the embodiments, described herein locally perform the processing in a conventional manner, e.g., substantially consistent and substantially uniform, while globally over the substrate, the materials, processes, and process sequences may vary. Thus, the testing will find optimums without interference from process variation differences between processes that are meant to be the same. It should be appreciated that a region may be adjacent to another region in one embodiment or the regions may be isolated and, therefore, non-overlapping. When the regions are adjacent, there may be a slight overlap wherein the materials or precise process interactions are not known, however, a portion of the regions, normally at least 50% or more of the area, is uniform and all testing occurs within that region. Further, the potential overlap is only allowed with material of processes that will not adversely affect the result of the tests. Both types of regions are referred to herein as regions or discrete regions.

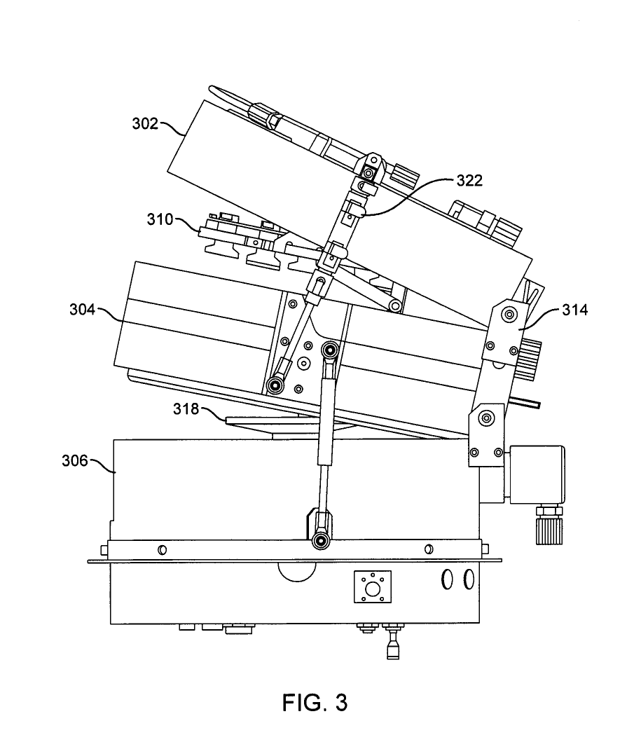

FIG. 3 is a simplified schematic diagram illustrating a perspective view of a multi-module cleaning chamber with the top cleaning module and the bottom cleaning module in an open position in accordance with one embodiment of the invention. Lid 302 is in an open position through the support of hinge 314 and support cylinder 322. In the open position, the top cleaning module enables access for a substrate to be delivered so that support assembly 310 may couple to the substrate. In one embodiment, an end effector may be used to transport a substrate to and from the cleaning module, as well as between the top and bottom cleaning modules. Mid portion 304 is also illustrated as opened thereby enabling access to the bottom cleaning module 306. It should be appreciated that mid portion 304 functions as a base for the top cleaning module and a lid for the bottom cleaning module. Hinge 314 and support cylinder 322 provide the support and force necessary for opening or lifting mid portion 304. When in an open position, bottom cleaning module enables access for a substrate to be placed on chuck 318. It should be appreciated that one exemplary operation may include isolating the combinatorially processed regions of a substrate in the top cleaning module and cleaning the external areas of the substrate in the top cleaning module. After the cleaning operation in the top cleaning module the substrate is transported to the bottom cleaning module 306 for a spin rinse and dry (SRD) operation.

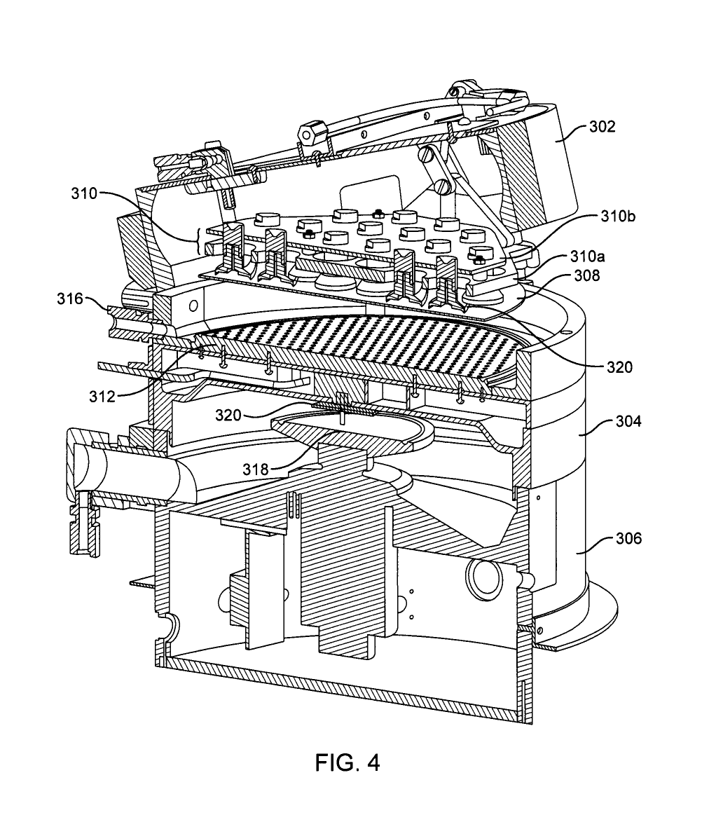

FIG. 4 is a simplified schematic diagram illustrating a cross-sectional view of a multi-module cleaning chamber in accordance with one embodiment of the invention. Lid 302 houses or encompasses top and side surfaces of support assembly 310 when the lid is in a closed position. Support assembly 310 includes top plate 310b disposed over bottom plate 310a. Top plate 310b has a plurality of holes disposed thereon. Cups are disposed through the plurality of holes within top plate 310b and a plurality of holes in top plate 310a that are substantially aligned with corresponding holes of the bottom plate. Substrate 308 is supported through cups 320, as will be described in more detail below. When lid 302 is in a closed position a bottom surface of substrate 308 will rest against chuck 312. Fitting 316 enables fluid flow to exit from the top cleaning module in one embodiment. As mentioned above, mid portion 304 functions as a bottom portion to the top cleaning module and a top portion of the bottom cleaning module. The bottom cleaning module, which includes base 306, functions as an SRD module in one embodiment. The SRD module includes chuck 318 that supports and rotates a substrate during a cleaning operation and a showerhead 320 disposed on a bottom surface of mid portion 304. The cleaning of the substrate in the SRD module utilizes cleaning chemistries at elevated temperatures, where the cleaning chemistries are delivered to a surface of a substrate being processed. It should be appreciated that the cleaning chemistries may be delivered through a nozzle or other suitable delivery mechanism. The elevated temperatures cause condensation to form on the ambient temperature surface of the ceiling of the SRD module, which is a bottom surface of mid-portion 304. The condensation on the ceiling of the SRD may cause droplets to form which can fall onto the surface of the substrate and introduce contaminants.

The embodiments described herein establish an inert gas curtain just prior to, or concurrent with flowing the cleaning chemistry at the elevated temperature. The inert gas curtain can be introduced through showerhead 320, as well as alternative types of showerheads, where each of the showerheads direct the flow from an inlet along the ceiling of the SRD module. The inert gas may be nitrogen in one embodiment and provides an inert gas curtain or layer along the top surface of the SRD module that effectively prevents the formation of condensation on the top surface when the heated chemistries are introduced. It should be appreciated that alternative inert gases may be utilized in some embodiments. It should be further appreciated that the inert gases may be supplied through an inlet port of mid portion 304 that is in fluid communication with showerhead 320. In some embodiments the inlet port is centrally located and extends through a top surface of the SRD module.

It should be appreciated that the material of construction for support assembly 310 and the cups, chuck 312, and chuck 318 may be any suitable material compatible with the cleaning fluids and operations, such as plastic, e.g., a fluoropolymer in one embodiment. In one embodiment, the chucks, linkages, covers and plates described herein are composed of Ethylene chlorotrifluoroethylene (ECTFE), the tubing is composed of Perfluoroalkoxy (PFA) PTFE: the basins and lid are composed of polytetrafluoroethylene (PTFE), and the o-rings are composed of a Perfluorinated Elastomer (FFKM). Further details on the multi cleaning module may be found in U.S. application Ser. No. 13/086,327 entitled “In-Situ Cleaning Assembly” and filed on Apr. 13, 2011, which is incorporated by reference.

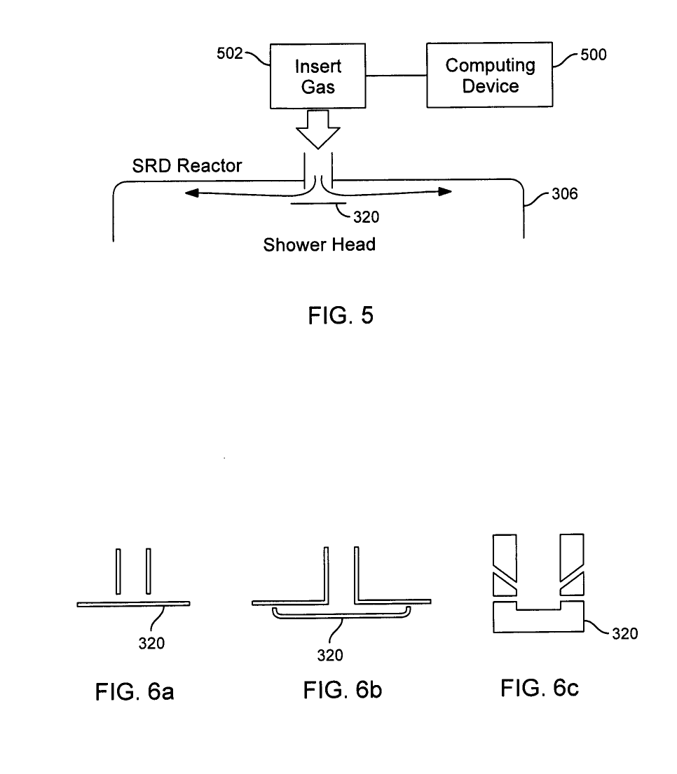

FIG. 5 is a simplified schematic diagram illustrating further details of the inert gas flow to the bottom cleaning module in accordance with some embodiments of the invention. Bottom cleaning module, which includes base 306, has showerhead 320 disposed under a centrally located inlet port extending through a top surface of the bottom cleaning module. Inert gas is supplied from inert gas supply 502, which is controlled by computing device 500. Computing device 500 may be any special purpose or general-purpose computer having a processor and memory to execute instructions for controlling the cleaning operations described herein. As illustrated in FIG. 5, the inert gas initially flows into the inlet with a direction of flow along an axis of the inlet. Showerhead 320 functions to modify the direction of flow radially outward along a top surface of the bottom cleaning module. After initiating the flowing of the inert gas along the top surface of the bottom cleaning module, or at least concurrent with the flowing of the inert gas, a cleaning chemistry may be dispensed onto a surface of a substrate supported by a chuck below showerhead 320. The cleaning chemistry can be dispensed through a nozzle or conveyed into the chamber to flow onto the surface of the substrate, among other known dispensing techniques. In some embodiments, the chuck is rotating as the cleaning chemistry is applied. As mentioned above, the cleaning chemistry may be at in elevated temperature from an ambient temperature, e.g., 85° C. The curtain of inert gas disposed along a top surface of the cleaning module prevents the formation of condensation on the top surface of the cleaning module. The avoidance of the condensation prevents any particles from falling onto the substrate when the substrate rotates during the drying cycle as droplets do not form on the ceiling of the SRD module.

Upon termination of the application of the cleaning chemistry, the flowing of the inert gas through the inlet and along the top surface of the bottom cleaning module is terminated. In some embodiments, the termination of the application of the cleaning chemistry and the termination of the flowing of the inert gas is concurrently performed. In alternative embodiments, the termination of the application of the cleaning chemistry and the termination of the flowing of the inert gas is performed such that the termination of the flowing of the inert gas occurs shortly after the termination of the application of the cleaning chemistry, e.g., 1 second thereafter. After termination of the flowing of the inert gas the substrate is dried through rotation of the chuck supporting the substrate. In some embodiments the chuck is rotated at 2000 rotations per minute for a period of time to dry the substrate. For example, the period of time may be 1.5 minutes and the cleaning chemistry may be deionized water having a temperature of at least 85° C. It should be appreciated that the flow of the inert gas is provided solely during the dispensing of the elevated temperature cleaning chemistry to provide a blanket or curtain of the inert gas along a top surface of the bottom cleaning module in some embodiments. In summary, once the dispensing of the cleaning chemistry initiates, the flowing of the inert gas concurrently commences or commences slightly before the dispensing of the cleaning chemistry, and when the dispensing of the cleaning chemistry terminates, the flowing of the inert gas concurrently terminates or terminates slightly after the termination of the dispensing of the cleaning chemistry in some embodiments. Thus, the embodiments provide for establishing an inert gas curtain during dispensing of the cleaning chemistry and not during the drying cycle where the substrate rotates without application of the cleaning chemistry.

FIGS. 6A through 6C illustrate various alternatives for the showerhead of the cleaning showerhead in accordance with one embodiment of the invention. FIG. 6A illustrates a reflector type showerhead where the inert gas is provided through an inlet and is redirected upon contacting a surface of the reflector of showerhead 320. The surface of the showerhead enabling the modifying of the flow direction of the inert gas is orthogonally disposed relative to an axis of the inlet. Thus as the flow of inert gas exits the inlet, the flow is redirected along the top surface of the SRD module to form a curtain of inert gas. FIG. 6B illustrates an alternative embodiment for showerhead 320. Showerhead 320 is disposed under a centrally located inlet to the bottom cleaning module. A surface of the showerhead 320 that redirects the flow of the inert gas is configured with the outer peripheral edges curved towards the top surface of the cleaning module. FIG. 6C illustrates a cross sectional view of a showerhead enabled to provide or redirect the flow from the inlet along multiple angles in accordance with one embodiment. Showerhead 320 has a plurality of channels defined their through in the embodiment of FIG. 6C. In some embodiments, the channels defined through showerhead 320 are annular channels. It should be appreciated that the angle for the multiple channels defined through showerhead 320 are less than or equal to 90° relative to an axis of the inlet. While FIG. 6C illustrates two channels, more or less channels may be provided as desired. It should be further appreciated that the embodiments described with regards to FIGS. 6A through 6C are exemplary and not meant to be limiting. That is, alternative showerheads may be integrated with the embodiments described herein where the showerhead functions to provide a curtain or flow along a top surface of the cleaning module in order to prevent condensation from forming thereon.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for cleaning a substrate, comprising:
receiving the substrate into a cleaning module;
flowing an inert gas into the cleaning module, the flowing including,
flowing the inert gas into an inlet defined within a top surface of the cleaning module;
modifying a direction of the flowing inert gas to flow radially along the top surface of the cleaning module;
after initiating the flowing, introducing a cleaning chemistry onto a surface of the substrate, the cleaning chemistry being at a temperature elevated from an ambient temperature;
terminating the introducing of the cleaning chemistry;
terminating the flowing of the inert gas after terminating the introducing of the cleaning chemistry; and
drying the substrate after terminating the flowing of the inert gas.

2. The method of claim 1, wherein the temperature of the cleaning chemistry is at least 85° C.

3. The method of claim 1, further comprising:
rotating the substrate while introducing the cleaning chemistry.

4. The method of claim 1, wherein the modifying the direction includes changing a flow direction of the inert gas by about 90 degrees.

5. The method of claim 1, wherein the modifying the direction includes concurrently providing multiple angles for the flow direction relative to an axis of a flow inlet.

6. The method of claim 5, wherein the multiple flow angles are each less than about 90 degrees relative to the axis of the flow inlet.

7. The method of claim 1, wherein the inert gas is nitrogen.

8. A cleaning module, comprising;
a top cleaning module disposed over a bottom cleaning module, wherein a mid portion of the cleaning module functions as a base of the top cleaning module and a top of the bottom cleaning module, the bottom cleaning module comprising:
a base portion housing a chuck, wherein a showerhead affixed to the top of the bottom cleaning module is disposed over the chuck; and
a controller communicating with the cleaning module, the controller having a processor operable to receive instructions which, when executed by the processor, cause the processor to perform a method comprising:
flowing an inert gas through the showerhead into the bottom cleaning module, the flowing including,
flowing the inert gas in a first direction into an inlet defined within a top surface of the cleaning module;
modifying the first direction of the flowing inert gas to a second direction, the second direction radially along the top of the bottom cleaning module;
introducing a cleaning chemistry onto a surface of the substrate, the cleaning chemistry being at a temperature elevated from an ambient temperature;
terminating introducing the cleaning chemistry;
terminating the flowing of the inert gas after terminating the introducing of the cleaning chemistry; and
drying the substrate after terminating the flowing of the inert gas.

9. The cleaning module of claim 8, wherein the showerhead is a plate having a surface that is disposed under the inlet, the surface orthogonal to an axis of the inlet.

10. The cleaning module of claim 9, wherein an outer edge of the showerhead is curved toward the top of the cleaning module.

11. The cleaning module of claim 8, wherein the showerhead has a plurality of channels having different angles relative to an axis of the inlet.

12. The cleaning module of claim 11, wherein the plurality of angles are each less than or equal to 90 degrees relative to the axis of the inlet.

13. The cleaning module of claim 11, wherein the plurality of channels are annular channels.

14. The cleaning module of claim 8, wherein the chuck is rotatable.
